(19) United States
(12) Patent Application Publication
(10) Pub. No.: US 2015/0136871 A1
(43) Pub. Date: May 21, 2015

(54) SCENT WICK DISPENSER

(71) Applicant: WILDLIFE RESEARCH CENTER, INC., Ramsey, MN (US)

(72) Inventor: Samuel A. Burgeson, Blaine, MN (US)

(21) Appl. No.: 14/547,944

(22) Filed: Nov. 19, 2014

Related U.S. Application Data
(60) Provisional application No. 61/906,145, filed on Nov. 19, 2013.

(51) Int. Cl. A01M 31/00

(52) U.S. Cl. CPC A01M 31/008
USPC 239/44

(57) ABSTRACT

Systems and devices for dispensing liquid scent and methods of using the same are disclosed herein. More specifically, the present disclosure relates to scent wick dispensers having an increased surface area, containers to be used with such scent wick dispensers and methods of using the same.

### CROSS REFERENCE TO RELATED APPLICATION

This application claims priority under 35 U.S.C. §119(e) to U.S. application Ser. No. 61/906,145, filed Nov. 19, 2013 and titled Scent Wick Dispenser, which is hereby incorporated by reference.

### TECHNICAL FIELD

The present disclosure relates to systems, devices and methods for dispensing liquid scent. More specifically, the present disclosure relates to scent wick dispensers and methods of using the same.

### BACKGROUND

Hunters often use animal attractant scent to increase the chances of hunting success. Use of these scents takes advantage of the natural survival instincts of an animal, including finding food, enacting defense mechanisms and finding a mate. For example, in the case of white tail deer, bucks use their nose to find food, to become aware of other deer in their territory, to avoid danger and to find a mate during mating season. A scent dispenser can be used to disperse a commercially available scent, such as doe secretions, and the buck will smell the scent and be drawn to the desired location, thereby making it easier to hunt.

Examples of commercially available scents, which may be sold with or without a device for dispensing the scents, may include, but are not limited to, doe urine, doe estrous secretions, and buck urine. Commercially available scents may also be artificial, man-made, made with other natural ingredients, or a combination.

Against this backdrop, the present disclosure was developed.

The information included in this Background section of the specification, including any references cited herein and any description or discussion thereof, is included for technical reference purposes only and is not to be regarded subject matter by which the scope of the invention is to be bound.

### SUMMARY

Aspects of the present disclosure address the aforementioned needs by providing systems and devices for dispensing liquid scent and methods of using the same.

In one aspect, a system for dispensing liquid scent is disclosed. The system may include a container configured to receive a liquid scent. The container includes an oblong body having a neck integrally formed with the body at a first end, the neck defining an opening therein, the oblong body having an internal raised surface at a second end. The system also includes a scent wick dispenser including a top portion having rounded corners and an aperture defined therein, an elongated dip portion having a rounded distal end, and an enlarged neck portion integrally connecting the top portion and the elongated dip portion. A length of the elongated dip portion substantially corresponds to a height of the container and a width of the enlarged neck and elongated dip portion of the scent wick dispenser substantially corresponds to a width of the neck and the opening defined in the container. In one aspect, the scent wick dispenser is a synthetic felt material having a thickness of approximately 0.4 inches. In one aspect, the container is a 4 oz container made from polyethylene terephthalate, with a fill capacity of approximately 118 mL±5 mL and a weight of approximately 24 g±1 g. In one aspect, the length of the elongated dip portion of the scent wick dispenser is between approximately 3.88 inches and approximately 4.74 inches. In one aspect, the width of the enlarged neck and elongated dip portion of the scent wick dispenser is between approximately 0.51 inches and 0.73 inches.

In some aspects, the system may further include the liquid scent. The liquid scent may include doe urine, doe estrous secretions, buck urine or a combination of any or all three. In one aspect, the rounded distal end of the scent wick dispenser has a radius of curvature of between approximately 0.28 inches and approximately 0.34 inches. In one aspect, the aperture in the top portion of the scent dispenser wick has a radius of between approximately 0.30 inches and approximately 0.38 inches. In one aspect, the rounded corners of the enlarged neck portion of the scent wick dispenser have a radius of curvature of between approximately 0.16 inches and 0.21 inches.

In one aspect, a scent wick dispenser is disclosed. The scent wick dispenser may include a top portion having rounded corners and an aperture defined therein, an elongated dip portion having a rounded distal end and configured to absorb a liquid scent, and an enlarged neck portion integrally connecting the top portion and the elongated dip portion. A ratio of a length of the elongated dip portion of the scent wick dispenser to a width of the enlarged neck and elongated dip portion of the scent wick dispenser is greater than 6. In one aspect, the ratio of the length of the elongated dip portion of the scent wick dispenser to the width of the enlarged neck and elongated dip portion of the scent wick dispenser is between approximately 6.19 and approximately 8. In one aspect, the ratio of a length of the elongated dip portion of the scent wick dispenser to the width of the enlarged neck and elongated dip portion of the scent wick dispenser is approximately 6.9. In one aspect, the scent wick dispenser is a synthetic felt material having a thickness of approximately 0.4 inches. In one aspect, the length of the elongated dip portion of the scent wick dispenser is between approximately 3.88 inches and approximately 4.74 inches. In one aspect, the width of the enlarged neck of the scent wick dispenser is approximately between approximately 0.51 inches and 0.73 inches. In one aspect, the width of the elongated dip portion of the scent wick dispenser is approximately between approximately 0.51 inches and 0.73 inches. In one aspect, the rounded distal end of the scent wick dispenser has a radius of curvature of between approximately 0.28 inches and approximately 0.34 inches. In one aspect, the aperture in the top portion of the scent dispenser wick has a radius of between approximately 0.30 inches and approximately 0.38 inches. In one aspect, the rounded corners of the enlarged neck portion of the scent wick dispenser have a radius of curvature of between approximately 0.16 inches and approximately 0.21 inches.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

The present disclosure, both as to its organization and manner of operation, may be understood by reference to the following description, taken in connection with the accompanying drawings, in which:

FIGS. 1A-1D depict a scent wick dispenser and corresponding scent container in accordance with the present disclosure.

FIGS. 2A-2D illustrate the dimensions of the scent bottle of FIGS. 1A-1D.

FIGS. 3A-3B illustrate the dimensions of the scent wick dispenser of FIGS. 1A-1D.

FIG. 4 illustrates a method of using the scent wick dispenser of FIGS. 1A-1D in accordance with the present disclosure.

### DETAILED DESCRIPTION

The present disclosure includes novel and advantageous systems and devices for dispensing liquid scent and methods of using the same. The systems and devices disclosed herein include a scent wick dispenser having an elongated dip portion to increase the surface area of the wick that is exposed to the liquid scent. The scent wick dispenser may further include an enlarged neck to further increase the surface area of the wick that is exposed to the liquid scent. Applications of the systems and devices include dispensing animal attractant in the form of liquid scent. Some examples of scents include doe urine, doe estrous secretions and buck urine. The scents may be artificial or man-made. Similarly, the scents may be used during any suitable time period and is not limited to mating season or hunting season or to any specific animal.

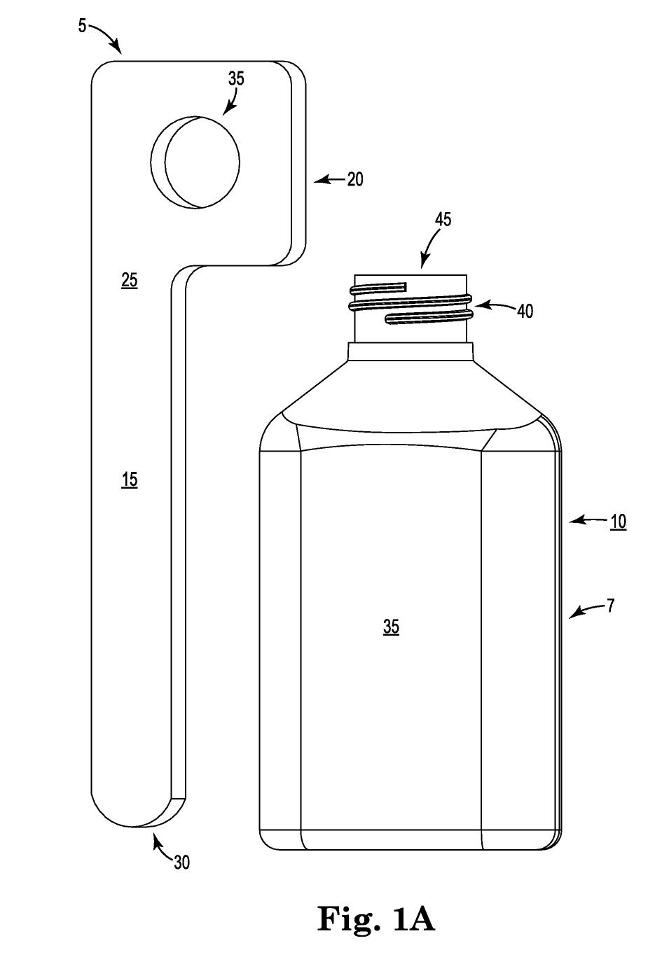

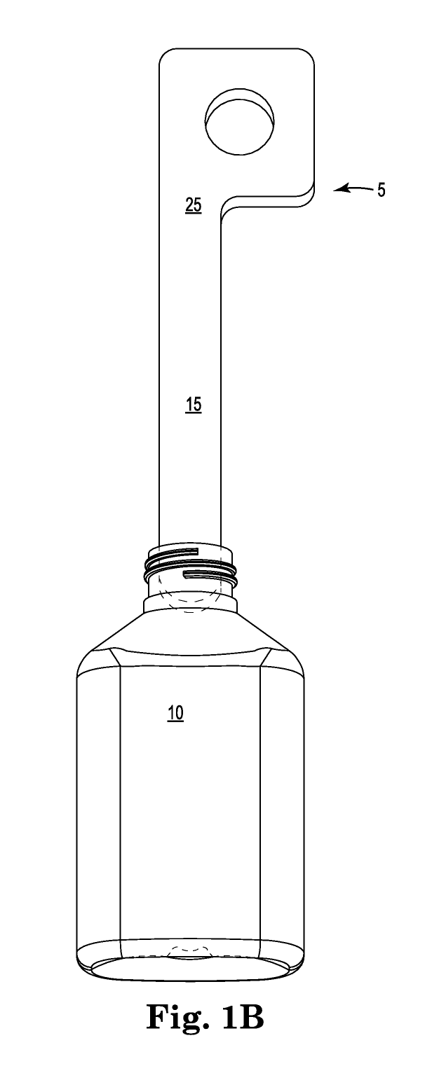

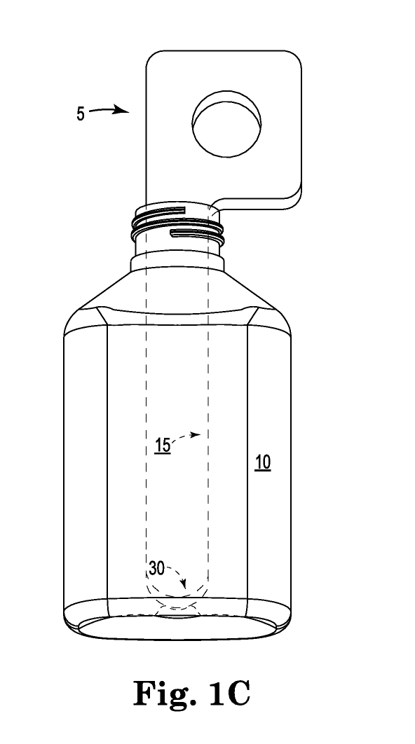

With reference to FIGS. 1A-1D, one embodiment of a scent wick dispenser 5 and scent and distribution container 10 are shown. FIG. 1A illustrates the scent wick dispenser 5 including an elongated dip portion 15 and a top portion 20 integrally connected by an enlarged neck portion 25. The elongated dip portion 15 has an increased surface area for absorbing liquid scent and may include a rounded distal end 30 configured to engage a raised internal surface 12 of the container 10 (see e.g., FIGS. 1C and 1D). The elongated dip portion 15 has a length that generally corresponds to a height of the container. For purposes of this disclosure, “generally corresponds” or “substantially corresponds” to a height or length of the container means that the length of the dip portion is approximately ±0.406 inches of the height or length of the container or ±10% of the height or length of the container. The top portion 20 of the scent wick dispenser 5 may include an aperture 35 for suspending the scent wick dispenser. In one embodiment, the aperture 35 is used to hang the scent wick dispenser 5 from, for example, a tree branch. The scent wick dispenser 5 is made from any appropriate absorptive material that does not alter or change the smell of the liquid used with the scent dispenser. In one embodiment, the scent wick dispenser is made from a synthetic felt having a thickness of about 4/10^{th} of an inch±10%.

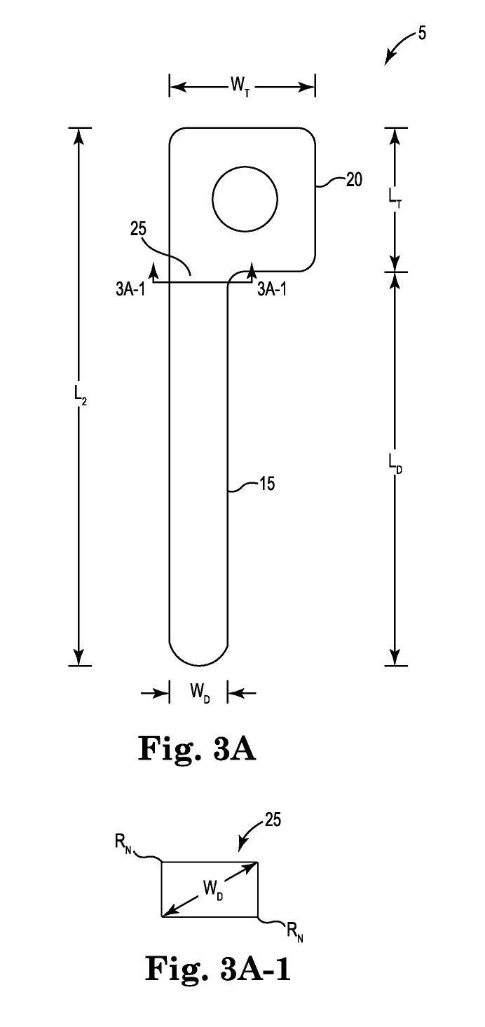

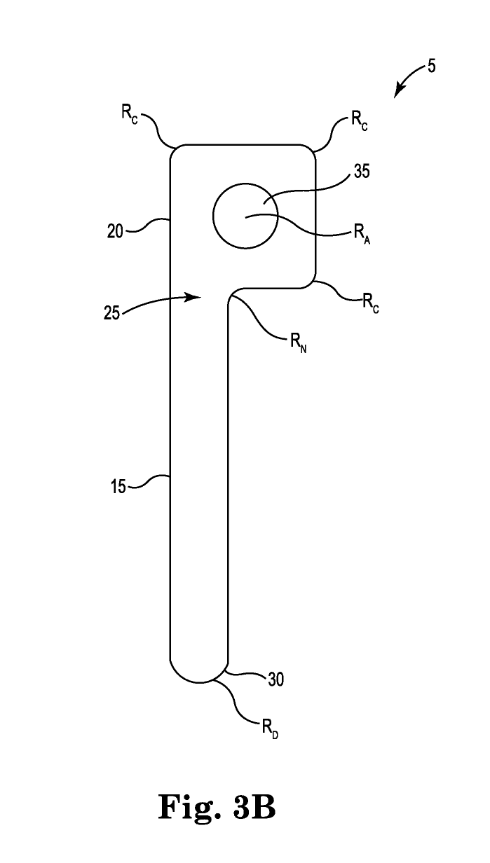

The container 10 includes an oblong body 35 with a neck 40 integrally formed with and extending from the body 35. The neck 40 defines an opening 45, which, together with the container 10, is configured to receive the elongated dip portion 15 of the scent wick dispenser 10 through the opening 45. The container 10 is also configured to receive and hold a liquid 7, such as a liquid scent. The container 10 may include an initial amount of liquid. In other embodiments, the container may be fillable/refillable with a liquid. The opening 45 may be used to fill and/or refill the container 10 with a liquid. The width or distance from corner to corner of the enlarged neck portion 25 of the scent wick 5 is substantially similar than the width (or diameter) of the neck 40 and opening 45 of the container 10. That is, and as shown in FIG. 1C and FIG. 3A-1 (a cross section of the neck 25 of the scent wick dispenser 10), the distance from corner to corner of the neck portion 25 of the wick 10 substantially stretches across the full diameter of the neck 40/opening 45 of the container 10. That is, in general, the corners of the neck 25 of wick 5 may contact the inner circumference of the neck 40/opening 45 of the container 10. For purposes of this disclosure, “generally corresponds” or “substantially corresponds” or “substantially similar” to the width (or diameter) of the neck 40 and opening 45 of the container means that the distance from corner to corner of the neck portion of the wick is ±0.27 inches of the width (or diameter) of the container. This configuration of the wick increases the amount of surface area of the wick that is exposed to and can absorb the liquid held in the container.

The container 10 may be manufactured from plastic, metal or metal alloy, composite, glass, etc., or any combination thereof. In some embodiments, the container material may be durable and inexpensive, such as embodiments made of plastic. In some embodiments, the container may be manufactured with a material that does not interfere with the properties of a liquid contained therein, such as the scent of the liquid. In one embodiment, the container 10 is a 4 oz F/L container made from polyethylene terephthalate or PETE, a thermoplastic polymer resin, with a fill capacity of approximately 118 mL±5 mL and a weight of approximately 24 g±1 g.

The liquid scent may be an animal attractant, including but not limited to an animal sexual attractant. For example, an animal sexual attractant used may include deer urine or a particular scent, produced by a doe when in heat. In alternative embodiments, other liquids may be used, such as animal and/or pest repellents, or scents that provide agreeable or disagreeable odors to humans, masking scents, or any other desired material. In yet further embodiments, the contents of the container may include gels or thick liquids. The liquid may be synthetic, natural, a synthetically produced natural substance, a mixture of these, or etc. In one embodiment, the liquid scent may comprise doe urine, doe estrous secretions, buck urine, or a combination of any or all three, and may also include additional or other scent ingredients or other appropriate additives.

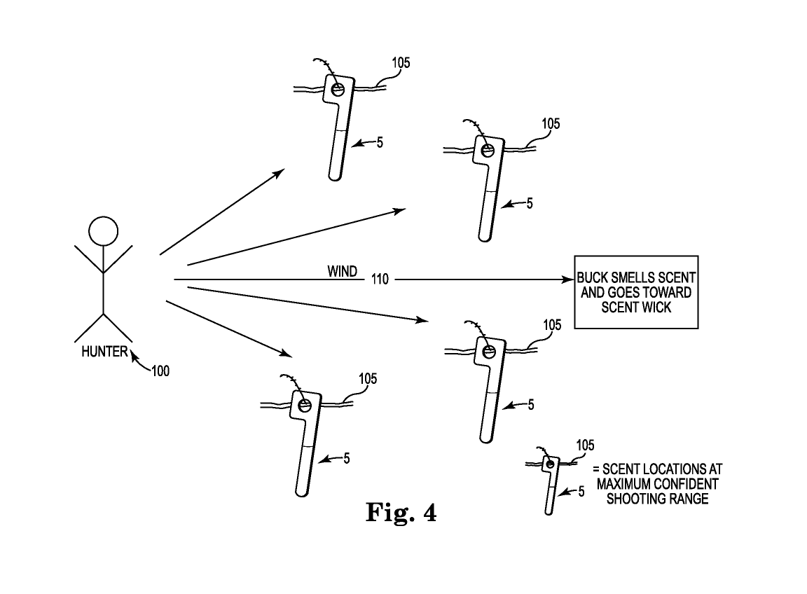

FIGS. 1B-1D further illustrate a method of using the scent wick dispenser 5 with the container 10. In use, the scent wick dispenser 5 is inserted into the container 10 containing a liquid 7. As shown in FIG. 1B, the width of the elongated dip portion 15 is sized to substantially correspond with the diameter of the container 10. As indicated in FIG. 10, the length of the elongated dip portion 15 is sized to substantially correspond with the length or depth of the container 10. As illustrated in FIG. 1D, the rounded distal end 30 may extend the full length or depth of the container 10 and, in some embodiments, may at least partially engage a raised portion 12 of the bottom 14 of the container 10. Once the wick 5 has absorbed the desired amount of liquid, the wick 5 is withdrawn from the container 10. The wick may then be hung from a tree branch or other location as indicated in FIG. 4, which is discussed in more detail below.

Advantageously, the scent wick dispenser 5 includes specific dimensions with an increased surface area that, when used with the custom designed container 10, increase absorption of the scent (liquid 7) contained in the container. The width of the elongated dip portion is specifically designed to fit snugly into the opening 45 of the container and the elongated dip portion extends the full length of the container thereby exposing the increased surface area to the liquid scent for increased absorption.

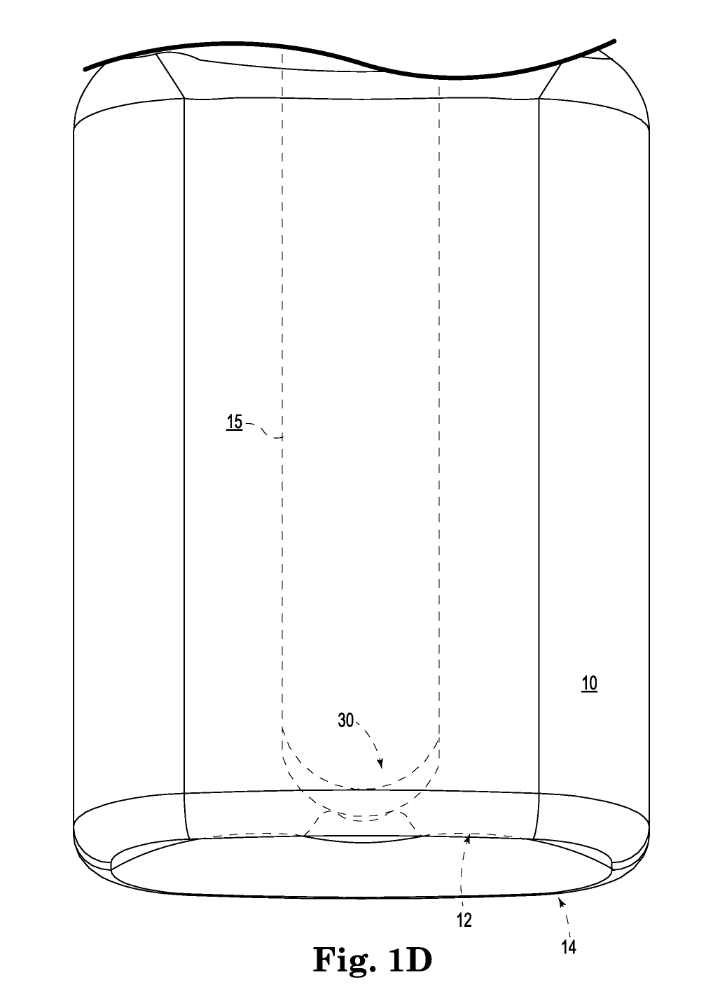

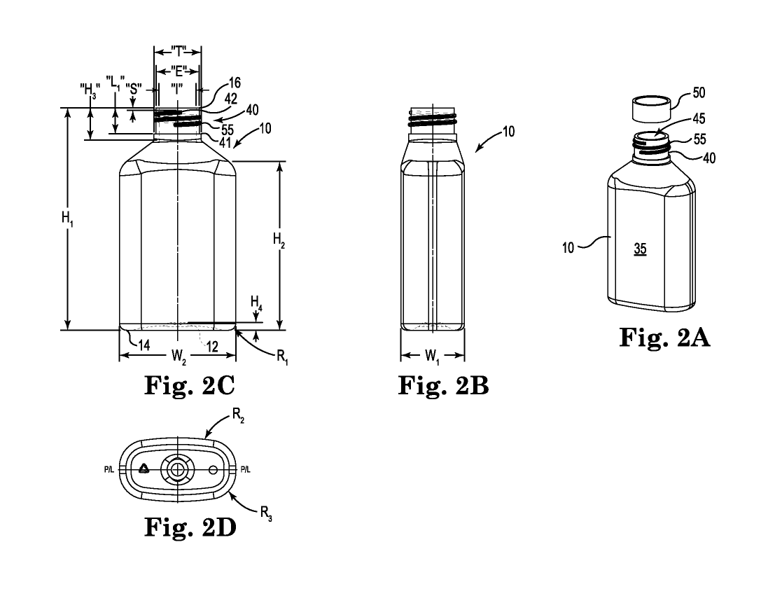

Referring now to FIGS. 2A-2D and 3A-3B, additional features and specific dimensions of one embodiment of the scent wick dispenser 5 and container 10 are shown. FIGS. 2A-2D illustrate one embodiment of the container 10. As can be understood from FIG. 2A, the container 10 may include a cap 50 for sealing the opening 45. The cap 50 is removable, so that the container can be filled/refilled with liquid as needed. The neck 40 and cap 50 may include corresponding threads 55 and be threadably engageable with one another. Although threads are illustrated on the outer surface of the neck 40, it is recognized that the threads may be on the inner surface of the neck 40. Similarly, the cap 50 may be engageable with the neck 40 in any manner other than or in addition to threads, including by a snap fit, friction fit, or etc.

As shown in FIG. 2B, the container 10 has a side width W₁ of 1.250 inches±0.050 inches. As indicated in FIG. 2C, the container 10 has a total length or height, H₁, from the bottom 14 to the top 16 of the container and a length or height H₂ from the bottom 14 to a shoulder portion 18 of the container 10 and a front width of W₂ and the height H₄ of the raised portion 12. In one embodiment, H₁ is approximately 4.346 inches±0.060, H₂ is approximately 3.300 inches, H₄ is approximately 0.150 inches and W₂ is approximately 2.30 inches±0.060. Various dimensions of the neck 40 and opening 45 are also shown in FIG. 2C. The neck 40 may have a total length or height H₃, with a length L₁ between the lip 41 and the top 16 of the container, a length S between a most distal thread 42 and the top 16 of the container 10 and a diameter T between the outermost surfaces of the threads 55. In one embodiment, H₃ is approximately 0.646 inches±0.015, L₁ is approximately 0.512 inches, S is approximately 0.046 inches±0.015 and T is approximately 0.932 inches±0.008. The opening 45 includes an inner diameter I and an outer diameter E. In one embodiment, I is approximately 0.732 inches and E is approximately 0.775 inches±0.008. FIGS. 2C and 2D also indicate the radius of curvature R₁, R₂ and R₃ of the container 10. In one embodiment, the radius of curvature R₁ is approximately 0.130 inches, R₂ is approximately 5.0 inches and R₃ is approximately 0.50 inches.

Turning now to FIGS. 3A and 3B, certain dimensions and features of one embodiment of the scent wick dispenser 5 are illustrated. As shown in FIG. 3A, in one embodiment, the wick 5 has a total length or height of L₂, which comprises the length of the dip portion L_{D} and the length of the top portion L_{T}. In one embodiment, L₂ is between approximately 5.58 inches and approximately 6.17 inches, L_{D} is between approximately 4.09 inches and approximately 4.52 inches and L_{T} is between approximately 1.48 inches and approximately 1.64 inches. In one embodiment, L₂ is between approximately 5.28 inches and approximately 6.43 inches, L_{D} is between approximately 3.88 inches and approximately 4.74 inches and L_{T} is between approximately 1.40 inches and approximately 1.71 inches. In one embodiment, L₂ is between approximately 5.72 inches and approximately 6.02 inches, L_{D} is between approximately 4.20 inches and approximately 4.41 inches and L_{T} is between approximately 1.52 inches and approximately 1.60 inches. In one embodiment, L₂ is approximately 5.875 inches, L_{D} is approximately 4.3125 inches and L_{T} is approximately 1.5625 inches. The elongated dip portion 15 of the wick 5 has a width W_{D} and the top portion 20 of the wick 15 has a width W_{T}. In one embodiment, W_{D} is between approximately 0.65 inches and approximately 0.59 inches and W_{T} is between approximately 1.64 inches and approximately 1.48 inches. In one embodiment, W_{D} is between approximately 0.51 inches and approximately 0.73 inches and W_{T} is between approximately 1.4 inches and approximately 1.71 inches. In one embodiment, W_{D} is between approximately 0.60 inches and approximately 0.64 inches and W_{T} is between approximately 1.52 inches and approximately 1.60 inches. In one embodiment, W_{D} is approximately 0.625 inches and W_{T} is approximately 1.5625 inches. In one embodiment, the ratio of L_{D} to W_{D} is greater than 6. In one embodiment, the ratio of L_{D} to W_{D} is less than 7. In one embodiment, the ratio of L_{D} to W_{D} is between approximately 8.1 and 6.1. In one embodiment, the ratio of L_{D} to W_{D} is approximately 6.9.

As shown in FIG. 3B, the distal end 30 of the wick 5 has a radius of curvature, R_{D}, the aperture 35 in the top portion 20 of the wick 5 has a radius R_{A}, the top portion 20 includes rounded corners having a radius of curvature R_{C} and the enlarged neck portion 25 has a radius of curvature of R_{N}. In one embodiment, the radius of curvature R_{D} is between approximately 0.28 inches and approximately 0.34 inches, the radius R_{A} is between approximately 0.30 inches and approximately 0.38 inches, the radius of curvature of the rounded corners, R_{C}, is between approximately 0.16 inches and approximately 0.21 inches and the radius of curvature of the neck portion R_{N} is between approximately 0.16 inches and approximately 0.21 inches. In one embodiment, the radius of curvature R_{D} is between approximately 0.29 inches and approximately 0.33 inches, the radius R_{A} is between approximately 0.31 inches and approximately 0.37 inches, the radius of curvature of the rounded corners, R_{C}, is between approximately 0.17 inches and approximately 0.2 inches and the radius of curvature of the neck portion R_{N} is between approximately 0.17 inches and approximately 0.2 inches. In one embodiment, the radius of curvature R_{D} is between approximately 0.30 inches and approximately 0.32 inches, the radius R_{A} is between approximately 0.32 inches and approximately 0.36 inches, the radius of curvature of the rounded corners, R_{C}, is between approximately 0.18 inches and approximately 0.19 inches and the radius of curvature of the neck portion R_{N} is between approximately 0.18 inches and approximately 0.19 inches. In one embodiment, the radius of curvature R_{D} is approximately 0.3125, the radius R_{A} is approximately 0.34375 inches, the radius of curvature of the rounded corners, R_{C}, is approximately 0.1875 inches and the radius of curvature of the neck portion R_{N} is approximately 0.1875 inches. In another embodiment, the radius R_{A} is approximately 0.375±0.0375 inches.

Turning now to FIG. 4, one or more scent wick dispensers 5 can be used to lure a hunting target. In use, once the scent wick dispenser 5 has been dipped into the container 10 having a desired liquid, such as a liquid scent, it is withdrawn from the container 10 and suspended from a tree branch 105 by a user 100, such as a hunter. Additional scent dispensers 5 may be suspended from tree branches 105 in other locations that represent the maximum confident shooting range of the hunter. Wind 110 will disperse the scent from the scent wick 5 drawing the desired hunting target within range.

In one embodiment, the scent wick dispenser 5 may be packaged for sale, distribution or use in a resealable or non-resealable bag in units of one, two or four, or other desired units. In another embodiment, the scent wick dispenser 5 may be packaged for sale, distribution or use as part of a kit or system including the container 10. The kit or system may include one or more scent wick dispensers and a container, and optionally, the container may be pre-filled with a desired liquid, such as a liquid scent or another liquid disclosed elsewhere herein. In some embodiments, the kit or system may further include a bottle or a refill bottle of the liquid scent or another liquid disclosed elsewhere herein.

All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention as claimed below. Although various embodiments of the invention as claimed have been described above with a certain degree of particularity, or with reference to one or more individual embodiments, those skilled in the art could make numerous alterations to the disclosed embodiments without departing from the spirit or scope of this invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A system for dispensing liquid scent, the system comprising
a container configured to receive a liquid scent therein, the container comprising
an oblong body having a neck integrally formed with the body at a first end, the neck defining an opening therein, the oblong body having an internal raised surface at a second end; and
a scent wick dispenser comprising
a top portion having rounded corners and an aperture defined therein;
an elongated dip portion having a rounded distal end; and
an enlarged neck portion integrally connecting the top portion and the elongated dip portion,
wherein:
a length of the elongated dip portion substantially corresponds to a height of the container;
a width of the enlarged neck and elongated dip portion of the scent wick dispenser substantially corresponds to a width of the neck and the opening defined in the container.

2. The system of claim 1, wherein the scent wick dispenser is a synthetic felt material having a thickness of approximately 0.4 inches.

3. The system of claim 1, wherein the container is a 4 oz container made from polyethylene terephthalate, with a fill capacity of approximately 118 mL±5 mL and a weight of approximately 24 g±1 g.

4. The system of claim 1, wherein the length of the elongated dip portion of the scent wick dispenser is between approximately 3.88 inches and approximately 4.74 inches.

5. The system of claim 1, wherein the width of the enlarged neck and elongated dip portion of the scent wick dispenser is between approximately 0.51 inches and 0.73 inches.

6. The system of claim 1 further comprising the liquid scent.

7. The system of claim 6, wherein the liquid scent comprises doe urine, doe estrous secretions, buck urine or a combination of any or all three.

8. The system of claim 1, wherein the rounded distal end of the scent wick dispenser has a radius of curvature of between approximately 0.28 inches and approximately 0.34 inches.

9. The system of claim 1, wherein the aperture in the top portion of the scent dispenser wick has a radius of between approximately 0.30 inches and approximately 0.38 inches.

10. The system of claim 1, wherein the rounded corners of the enlarged neck portion of the scent wick dispenser have a radius of curvature of between approximately 0.16 inches and 0.21 inches.

11. A scent wick dispenser comprising
a top portion having rounded corners and an aperture defined therein;
an elongated dip portion having a rounded distal end and configured to absorb a liquid scent; and
an enlarged neck portion integrally connecting the top portion and the elongated dip portion,
wherein:
a ratio of a length of the elongated dip portion of the scent wick dispenser to a width of the enlarged neck and elongated dip portion of the scent wick dispenser is greater than 6.

12. The scent wick dispenser of claim 11, wherein the ratio of a length of the elongated dip portion of the scent wick dispenser to the width of the enlarged neck and elongated dip portion of the scent wick dispenser is between approximately 6.19 and approximately 8.

13. The scent wick dispenser of claim 11, wherein the ratio of a length of the elongated dip portion of the scent wick dispenser to the width of the enlarged neck and elongated dip portion of the scent wick dispenser is approximately 6.9.

14. The system of claim 11, wherein the scent wick dispenser is a synthetic felt material having a thickness of approximately 0.4 inches.

15. The system of claim 11, wherein the length of the elongated dip portion of the scent wick dispenser is between approximately 3.88 inches and approximately 4.74 inches.

16. The system of claim 11, wherein the width of the enlarged neck of the scent wick dispenser is approximately between approximately 0.51 inches and 0.73 inches.

17. The system of claim 11, wherein the width of the elongated dip portion of the scent wick dispenser is approximately between approximately 0.51 inches and 0.73 inches.

18. The system of claim 11, wherein the rounded distal end of the scent wick dispenser has a radius of curvature of between approximately 0.28 inches and approximately 0.34 inches.

19. The system of claim 11, wherein the aperture in the top portion of the scent dispenser wick has a radius of between approximately 0.30 inches and approximately 0.38 inches.

20. The system of claim 11, wherein the rounded corners of the enlarged neck portion of the scent wick dispenser have a radius of curvature of between approximately 0.16 inches and approximately 0.21 inches.
